(19) United States
(12) Patent Application Publication
(10) Pub. No.: US 2026/0239095 A1
(43) Pub. Date: Aug. 13, 2026

(54) METHODS RELATED TO SERVICE REQUEST PROCEDURES APPLIED TO PDU SEESSIONS OF EXTENDED REALITY AND MEDIA SERVICES IN 5G SYSTEMS

(71) Applicant: Google LLC, MOUNTAIN VIEW, CA (US)

(72) Inventor: Ching-Yu LIAO, Mountain View, CA (US)

(21) Appl. No.: 19/154,639

(22) PCT Filed: Feb. 9, 2024
(86) PCT No.: PCT/US2024/015124

§ 371 Date: Aug. 7, 2025

Related U.S. Application Data
(60) Provisional application No. 63/484,456, filed on Feb. 10, 2023.
(60) Provisional application No. 63/541,507, filed on Sep. 29, 2023.

(51) Int. Cl. H04W 28/02; H04L 67/131; H04W 48/16

(52) U.S. Cl. CPC H04W 28/0268; H04L 67/131; H04W 48/16

(57) ABSTRACT

Methods and devices in a wireless network wireless communication are directed to informing core network functions about a radio access network node's ability to provide extended reality and media services in a service request procedure context. A radio access network node serving a user equipment receives a message requesting activation of an already-established Packet Data Unit session. The radio access network node then transmits a service request for activating the already-established PDU session and an indication as to whether the node is able to provide extended reality and media services, to a core network element performing a core network function such as AMF or SMF.

### FIELD OF THE DISCLOSURE

This document generally describes methods and devices operating in wireless communication systems such as (but not limited to) the ones described in fifth generation (5G) standard documents, known as 3^{rd} Generation Partnership Project (3GPP) communication systems. More particularly, some embodiments are related to a service request (SR) procedure for activating a user plane connection for an already-established packet data unit (PDU) session for providing extended reality and media (XRM) services to a user equipment (UE).

### BACKGROUND

This background description is provided for the purpose of generally presenting the technical context and problems. Work of the presently named inventors, to the extent it is described in this background section, as well as described aspects that may not otherwise qualify as prior art at the time of filing, are neither expressly nor impliedly admitted as prior art against the present disclosure.

Nowadays wireless networks are configured to support a variety of services with highly variable Quality-of-Service (QOS) requirements. The 5G networks have become able to provide XRM services. Currently, a session management function (SMF) of a 5G core network (CN) directs a PDU session anchor (PSA) user plane function (UPF) to activate an XRM flow based on a specific quality of service (QOS) handling. Policy and charging control (PCC) rules contain PDU set based QoS parameters (e.g., PDU set delay budget, PDU set error rate, etc.) that determine the specific QoS handling.

A PDU set includes one or more PDUs carrying the payload of one unit of information generated at application level. In case of an XRM application, a PDU set may be a frame or video for XR services. In order to provide XRM services based on PDU sets to a UE, a radio access network (RAN) node (e.g., next generation (NG)-RAN node) serving the UE has to be able to handle PDU sets and provide PDU Set based QOS for XRM applications. All the PDUs of a PDU set are transmitted with the same QOS flow.

Conventional wireless networks may be heterogeneous from the point of view of the RAN nodes' ability to perform PDU Set based QoS handling. When an already-established PDU session is activated, providing PDU Set based QoS for XRM services to a UE may be uncertain depending on whether a RAN node currently serving the UE is able to handle PDU sets based QoS flows for XRM applications. If the RAN node is unable and the core network (e.g., SMF) is not aware that the RAN node is unable to handle PDU sets based QoS flows for XRM applications, an application function (AF) repeatedly but unsuccessfully requests the CN to provide the PDU Set based QoS flows for the UE's XRM application thereby wasting communication resources and energy.

A similar problem occurs when the UE switches from an idle state to a connected state. While the UE was in idle state, its serving RAN node may have changed or a handover may have switched the UE to another RAN node, causing UE's currently serving RAN node to have a different XRM service capability than the RAN node that served the UE before the UE entered the idle state.

### SUMMARY

In some embodiments, a UE method includes transmitting an XRM service indication in a message (e.g., a radio resource control (RRC) message) initiating a service request (SR) procedure. Upon receiving this message, a RAN node (e.g., an NG-RAN node) serving the UE transmits an SR message indicating its XRM service capability (SC) for PDU Set based QoS handling (also called for the remainder of this document “XRM SC indication”), to a CN element hosting an Access and Mobility Management Function (AMF). This CN element then sends RAN's XRM SC indication, to an SMF (e.g., using a PDU session update message continuing the SR procedure). Depending on the RAN's XRM SC indication, the SMF prompts a user plane function (UPF) to set up a PDU sets based QoS flows for UE's XRM application.

According to another embodiment, a CN element hosting an AMF stores an XRM service indication per established PDU session. Upon receiving an SR message requesting activation of a particular already-established PDU session that, according to the XRM service indication requires XRM service capability, the CN element retrieves the currently service RAN node's XRM SC indication for the RAN node currently serving the UE. The CN element then conveys the RAN node's XRM SC indication to an SMF that continues the SR procedure. In another embodiment, a CN element hosting an SMF receives, from an AMF, a PDU Session update message related to a PDU session that requires a currently used RAN node to be able to provide PDU Set based QoS for XRM services. This CN element then prompts the AMF to retrieve XRM SC information from the RAN node serving the UE and causing the PDU Session update request.

According to yet another embodiment, a RAN node receives, from a UE, a message initiating an SR procedure. The RAN node then transmits an SR message with a RAN's XRM SC indication upon determining that at least one PDU session targeted by the SR procedure requires the NG-RAN node to be able to provide PDU Set based QoS for XRM services.

According to another embodiment, a UE initiates service request procedure for activating an already-established Packet Data Unit, PDU, session by transmitting a PDU session activation request including an establishment cause or an XRM service indication.

### BRIEF DESCRIPTION OF THE DRAWINGS

The accompanying drawings, which are incorporated in and constitute a part of the specification, illustrate one or more embodiments and, together with the description, explain these embodiments.

FIG. 1 is a block diagram of a wireless communication system in which a UE, a RAN node and a CN element perform methods according to various embodiments.

FIG. 2 is a signal diagram illustrating a NG-RAN node sending its XRM service capability to a CN when an SR procedure is initiated according to an embodiment.

FIG. 3 is a signal diagram illustrating an AMF function retrieving the XRM service capability from an NG-RAN node according to an embodiment.

FIG. 4 is a signal diagram illustrating an AMF function retrieving XRM service capability information from an NG-RAN node within an SR procedure context according to another embodiment.

FIG. 5 is a signal diagram illustrating the CN acquiring XRM service capability information within an SR procedure context according to an embodiment.

FIG. 6 is a signal diagram illustrating an SMF function initiating XRM service capability information retrieval within an SR procedure context according to another embodiment.

FIG. 7 is another signal diagram illustrating an NG-RAN's XRM service capability information exchanged within a SR procedure context according to an embodiment.

FIG. 8 is another signal diagram illustrating an NG-RAN providing its XRM service capability to the core network in an acknowledgement message according to an embodiment.

FIG. 9 is a flowchart of a method performed by a CN element in an SR procedure context according to an embodiment.

FIG. 10 is a flowchart of a method performed by an NG-RAN node in an SR procedure context according to an embodiment.

FIG. 11 is a flowchart of a method performed by a UE in an SR procedure context according to an embodiment.

### DETAILED DESCRIPTION

Methods and devices described in this section embody techniques related to re-activating an XRM service provided to a UE via a service request procedure or after the UE was in an idle state. The embodiment descriptions in this section refer to the accompanying drawings. The same reference numbers in different drawings identify the same or similar elements. The detailed descriptions do not preclude other embodiments within the scope of the appended claims (for example, applying one or more methods to other radio access technology (RAT) than 5G). The embodiments are not limited to the described configurations but may be extended to other arrangements.

Currently, the 5G system (5GS) lacks procedures for informing the CN about a RAN node's XRM service capability (which includes but may not be limited to a PDU set based QoS handling capability) of a RAN node currently serving a UE when re-activating UE's already-established PDU Sessions for XRM services. Various 3GPP working groups develop procedures for the 5G system to support advanced media services, e.g., High Data Rate Low Latency (HDRLL) services, AR/VR/XR services, and tactile/multi-modality communication services. The objectives of these working groups include, among others, enhancements to the network exposure procedures to support interaction between 5GS and XRM applications, and enhancements of QoS and policy for XRM service transmission.

A PDU set based QoS handling by an NG-RAN node is determined by the PDU set QoS parameters (which are included in the QoS profile of the QoS flow, as specified in 3GPP Technical Specification (TS) 23.501) and PDU set information in the GTP-U header (GTP-U is a protocol employed by 5G for the user plane data transfer) supplied by the PDU session anchor (PSA) user plane function (UPF). The PSA UPF is typically the last UPF in the chain of UPFs that connect the UE to a data network (DN). The SMF instructs the PSA UPF to perform PDU set identification and marking and may provide the PSA UPF with the Protocol Description indicating the header (e.g., real time transport protocol (RTP)/secure RTP (SRTP)) and payload type (e.g. H.264) used by the service data flow(s) of a media stream from the application server. Based on the instructions from the SMF for each downlink (DL) PDU received on an N6 interface for which PDU set based QoS handling is applied, the PSA UPF applies the rules for PDU set identification and provides PDU set information for the NG-RAN node in the GTP-U header.

In order to support XRM services with PDU set based QoS handling in a 5G system, the NG-RAN node needs to be aware of XRM services provided by the CN, and the CN of the NG-RAN's ability to handle such XRM services. The NG-RAN node may be configured to handle PDU sets based on PDU set QoS parameters, which the SMF provides in the QoS profile, over an N2 interface. Also, the NG-RAN needs to receive the PDU set information from the UPF (over the N3 interface) for the downlink XRM traffic, and/or from the UE, over the Uu interface, for the uplink XRM traffic.

The 5G core (5GC) handles QoS provisioning based on the NG-RAN's XRM services capabilities. In order to perform QoS flow binding based on a service data flow, configure the UPF with rules for PDU set identification and marking, and provide QoS profiles that include PDU Set based QoS parameters, to the NG-RAN node, the SMF needs to be aware of the NG-RAN node's XRM service capabilities. In addition, when there is a change of the NG-RAN node that results in the change of the associated XRM service capabilities (e.g., the UE or the network initiates a service request procedure or a UE switches out of an idle state), the SMF needs an update.

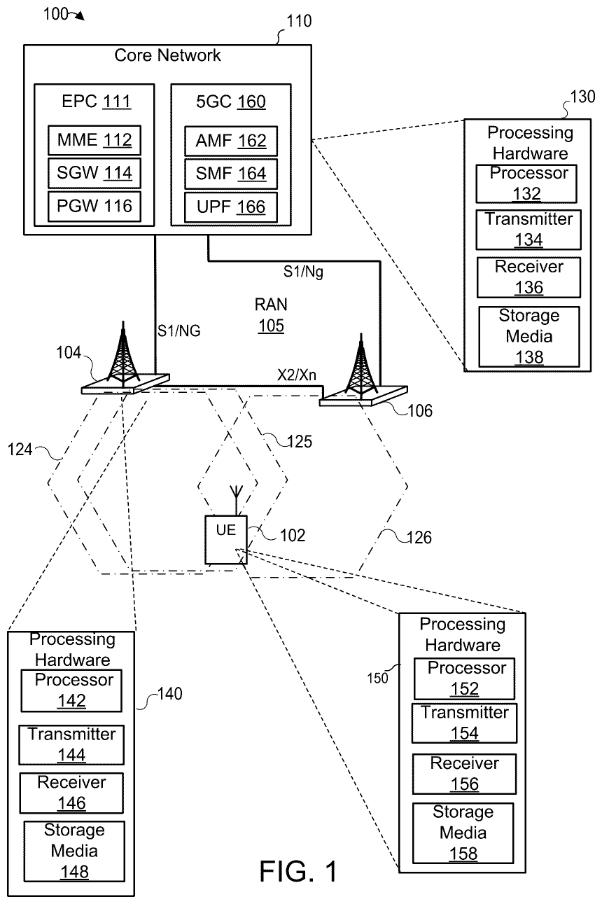

Before discussing various solutions to the problems noted above, a wireless communication system 100 in which a UE, a RAN node and a CN element perform methods according to various embodiments is described using the block diagram in FIG. 1. The wireless communication system 100 includes a UE 102, a first RAN node 104, a second RAN node 106, and a CN element 110 (sometimes called shorter “CN”). The RAN 105 connects RAN nodes 104 and 106 to the CN element 110. The CN element 110 may host an evolved packet core (EPC) 111 (i.e., non-5G system), a 5G core (5GC) 160, and/or a sixth generation (6G) core. The RAN 105 may be a 5G RAN or an LTE RAN.

FIG. 1 illustrates the first RAN node 104 as covering (i.e., intermediating communication with UEs located within) a first cell 124 and a second cell 125 and the second RAN node 106 covers a cell 126. Cells (e.g., 124, 125, and 126) served by a gNB (e.g., first RAN node 104 and/or 106) are NR cells, while cells served by an ng-eNB or eNB are evolved universal terrestrial radio access (E-UTRA) cells. The cells 124, 125, and 126 may be in the same Radio Access Network Notification Areas (RNA) or different RNAs. In general, the RAN 105 can include any number of RAN nodes, and each of the RAN node can cover one, two, three, or any other suitable number of cells. The UE 102 can support a 5G NR (or simply, “NR”) or E-UTRA air interface to communicate with the RAN nodes 104 and/or 106. Each of the RAN node 104, 106 may connect to elements of the CN element 110 via a CN-based interface (e.g., an S1 or an Ng interface). The RAN nodes 104 and 106 may also be interconnected via an interface (e.g., X2 or Xn interface) for interconnecting RAN nodes.

Among other components, the EPC 111 can include a Mobility Management Entity (MME) 112, a Serving Gateway (SGW) 114, and a Packet Data Network Gateway (PGW) 116. The MME 112 is configured to manage authentication, registration, paging, and other related functions and the SGW 112 is configured to transfer user-plane packets related to audio calls, video calls, Internet traffic, etc. The PGW 116 provides connectivity from the UE to one or more external packet data networks, e.g., an Internet network and/or an Internet Protocol (IP) Multimedia Subsystem (IMS) network.

The 5GC 160 includes an Access and Mobility Management Function (AMF) 162, a Session Management Function (SMF) 164 and a User Plane Function (UPF) 166 among other functions not illustrated therein. Each of these functions may be hosted by a CN element including processing hardware 130. In one embodiment illustrated in FIG. 1, the processing hardware 130 includes a processor 132, a transmitter 134, a receiver 136, and a memory 138 (which may store executable instructions for the processor to perform, in collaboration with the receiver and the transmitter, various methods further described). The same CN element may execute more than one CN function or instances of a CN function. The AMF 162 is configured to manage authentication, registration, paging, and other related functions, the SMF 164 is configured to manage PDU sessions, and the UPF 166 is configured to transfer user-plane packets related to audio calls, video calls, Internet traffic, etc.

The first RAN node 104 is equipped with processing hardware 140 that may include one or more general-purpose processors and/or special-purpose processing units. The processing hardware 140 illustrated in FIG. 1 includes a processor 142 configured to process data that the first RAN node 104 transmits in the downlink (DL) direction (i.e., to a UE), or receives in the uplink (UL) direction (i.e., from a UE). The processing hardware 140 also includes a transmitter 146 configured to transmit data in the DL direction and a receiver 144 configured to receive data in the UL direction (or, alternatively, a transceiver performing both transmitting and receiving data). The processing hardware 140 may also include a non-transitory computer-readable memory 148 storing instructions that the one or more general-purpose processors execute. The second RAN node 106 can include generally similar components.

The UE 102 is equipped with processing hardware 150 that includes one or more general-purpose processors and/or special-purpose processing units. The processing hardware 150 illustrated in FIG. 1 includes a processor 152 to process UL data that the UE 102 transmits, and/or DL data the UE receives. The processing hardware 150 also includes a transmitter 156 configured to transmit UL data and a receiver 154 configured to receive DL data (or, alternatively, a transceiver performing both transmitting and receiving data). The processing hardware 140 may also include a non-transitory computer-readable memory 158 storing machine-readable instructions executable on the one or more general-purpose processors, and/or special-purpose processing units.

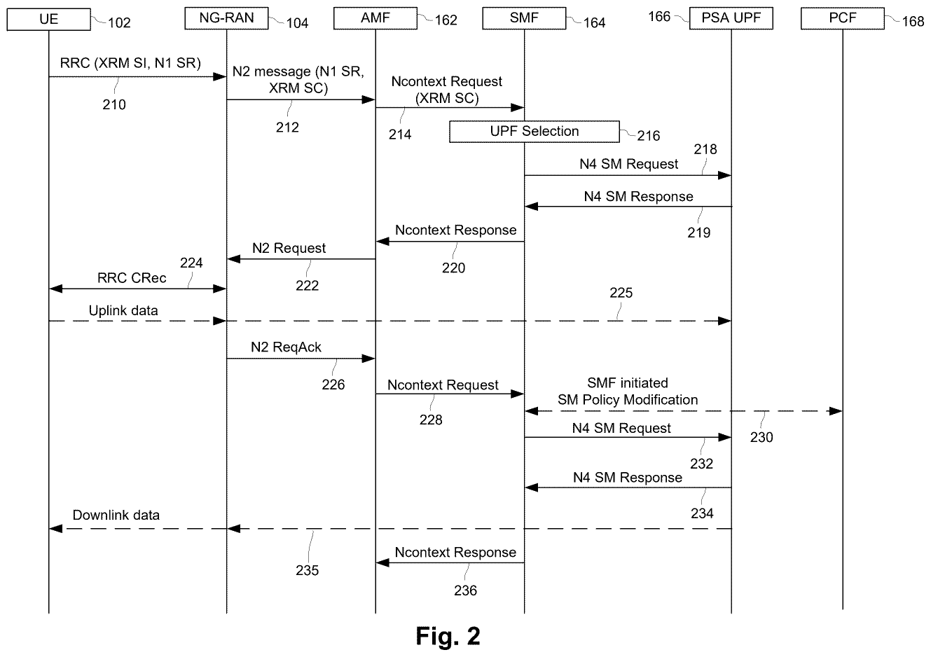

FIGS. 2-7 now described are signal diagrams illustrating various techniques related to re-activating an PDU Session containing QoS flows for XRM services provided to a UE via a service request procedure or after the UE was in an idle state. These signal diagrams illustrate messages exchanged in a wireless system like system 100 considering that the radio access technology is 5G. Therefore, the entities participating to message exchanges and performing actions as illustrated in these signal diagrams are 5G entities: an NG-RAN node 104 and 5GC core functions (AMF 162, SMF 164, PSA UPF 166, PCF 168). However, the illustrated techniques may be applied to wireless communication systems using other RAT with similar functions and entities. In these signal diagrams, time flows from top to bottom, that is, events or actions illustrated higher occur before events or actions illustrated lower therein. Same reference numbers are used to label substantially similar messages or actions and their description is then omitted.

FIG. 2 is a signal diagram illustrating an NG-RAN node 104 sending indication on its XRM service capability to a CN element when a UE 102 initiates an SR procedure according to an embodiment. A UE 102 may initiate an SR procedure by sending 210 a request (e.g., an N1 service request (N1 SR)) to activate user plane (UP) connection for one or more already-established PDU sessions (i.e., the already-established sessions are available in the UE). Note that the SR procedure may also be network triggered. The N1 SR may be conveyed via a radio resource control (RRC) message and N1 is a Non-Access Stratum (NAS) protocol between a core network and a UE. The N1 SR includes a list of the one or more already-established PDU sessions. The UE may also selectively specify an XRM service indication (XRM SI) in the RRC message (i) if any one of PDU sessions included in the list of PDU sessions to be activated provides XRM services with PDU set handling and/or (ii) if a UE PDU session in UE's PDU session status provides XRM services with PDU set handling.

Upon receiving the XRM SI, the NG-RAN node 104 (which may be simpler called hereinafter “NG-RAN”) transmits 212 an N2 message to the AMF 162, the message encapsulating the N1 SR and the NG-RAN's XRM service capability (SC). The XRM SC indicates whether the NG-RAN 104 is able to support XRM services with PDU set based QoS. N2 is a network interface between the CN and NG-RANs. A CN element with processing hardware such as processing hardware 140 illustrated in FIG. 1 hosts (i.e., executes) the AMF 162. The same CN element or another similar CN element hosts the other functions illustrated in the signal diagrams. Moreover, a CN element may host multiple instances of CN functions.

The AMF 162 then indicates the XRM SC of NG-RAN 104 to the SMF 164 via an Ncontext Request message (e.g., an Nsmf_PDUSession_updateSMContext Request as defined in 3GPP technical specifications modified to include the XRM SC indication). For simplicity, the description now refers to a single already-established PDU session for providing PDU Set based QoS for XRM services to the UE. Obtaining the XRM SC indication enables the SMF 164 to take NG-RAN's ability to handle XRM with PDU sets QoS flows into account when selecting 216 a UPF for QoS binding and QOS flow configuration. After the SMF 164 selects the PDU session anchor (PSA) UPF 166 for the activation of a UP connection for the already-established PDU session, the SMF transmits 218 an N4 session modification (SM) request message to the PSA UPS 166 and then receives 219 an N4 Session Modification response message therefrom.

The SMF instructs the UPF to enable PDU Set identification and marking on the PDU Set based QoS flows for the already-established PDU session based on the indication. N4 is a protocol used between control plane functions such as SMF and user plane functions such as UPF. The N4 SM response includes a CN N3 tunnel info for the uplink from the UPF based on the PCC rules from the PCF. An N3 tunnel is a GTP-U tunnel, GTP-U being a specific type of tunneling protocol.

The SMF 164 then replies 220 to AMF's Ncontext request message with an Ncontext response (e.g., an Nsmf_PDUSession_UpdateSMContext message) that includes N2 SM information (e.g., a PDU session identifier, a quality flow identifier QFI, QoS profile, CN N3 Tunnel Info, etc.), an N1 SM container, and a cause if the SMF rejects the activation of UP of the PDU Session.

The AMF 164 then sends 222 an N2 request message to the NG-RAN 104. This N2 request message includes the N2 SM information received from the SMF, and a mobility management (MM) NAS service accept. The NG-RAN 104 then also stores QoS information for the QoS flows of the PDU session that is activated and N3 tunnel's identifier in the UE RAN context. The MM NAS service accept includes PDU session's status in AMF. A PDU session reactivation result for the PDU sessions in the list of PDU sessions to be activated is provided in the service accept.

The NG-RAN 104 then performs a RRC connection reconfiguration 224 with the UE 102 depending on the QoS information for all the QoS flows of the PDU sessions whose UP connections are activated. After the UP radio resources are setup, the uplink data from the UE can now be forwarded 225 via the NG-RAN 105 to the UPF address and using the identified CN tunnel.

The NG-RAN 104 then replies to the AMF's N2 request by sending 226 an N2 request acknowledging (ReqAck) message. This message contains: AN tunnel info, and a subset of the list of PDU sessions to be established with N2 SM information (i.e., the list of accepted/rejected QoS Flows for the PDU Sessions whose UP connections are activated).

The AMF 162 then sends 228, to the SMF 164, an Ncontext request message (e.g., a Nsmf_PDUSession_UpdateSMContext request) including the N2 SM information per PDU Session. The AMF thus forwards the N2 SM information to the relevant SMF for each PDU Session identifier. The UE may then receive 235 DL data via the NG-RAN 104.

If a dynamic policy and charging control (PCC) is deployed and if policy control request trigger condition(s) have been met (e.g., change of an access type, change of the UE's location), the SMF 164 initiates 230 a SM policy modification procedure as defined in current 3GPP technical specifications. The policy and control function (PCF) 168 may provide updated policies. If the PCC rule(s) are updated, the SMF 164 may initiate a N4 session modification procedure to the PSA UPF 166 based on the updated PCC rule(s) by sending 232 an N4 session modification request and then receiving, from the PSA UPF 166, an N4 session modification response.

The SMF 164 replies to AMF's Ncontext request message by sending 236 an Ncontext response message (e.g., an Nsmf_PDUSession_UpdateSMContext Response message).

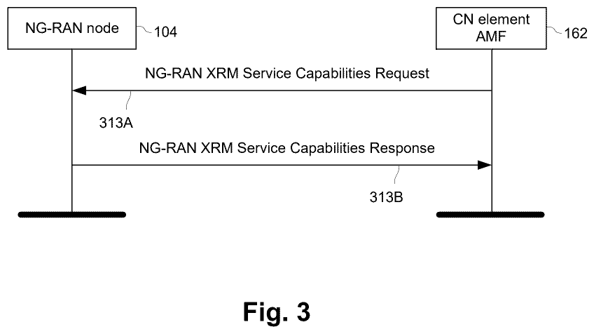

In the scenario illustrated in FIG. 2, the NG-RAN's and the CN function's actions are modified upon receiving the UE's XRM service indication, but the AMF may retrieve the NG-RAN's service capability absent UE's indication as illustrated in the FIG. 3. The signal diagram in FIG. 3 illustrates a CN element hosting AMF 162 (which is simpler called “AMF 162” in the following description) retrieving the XRM service capability from the NG-RAN node 104 according to an embodiment. The CN element hosting AMF 162 stores UE context information including an XRM service indication per PDU session obtained from the SMF during PDU Session establishment procedures. Based on this UE context information, when a PDU session to be activated is for XRM services to be provided using PDU sets based QoS according to the XRM service indication, the AMF 162 sends 313A an NG-RAN XRM service capability request (e.g., an N2 message) to NG-RAN 104. In response, the AMF 162 receives 313B an NG-RAN XRM service capability response (which may also be an N2 message) from the NG-RAN 104. The AMF then indicates the NG-RAN's XRM service capability to the SMF(s) that are associated to the PDU Sessions to be activated so that the SMF(s) can take this information into account for QoS binding and NG-RAN/UPF configuration for PDU Set based QoS handling.

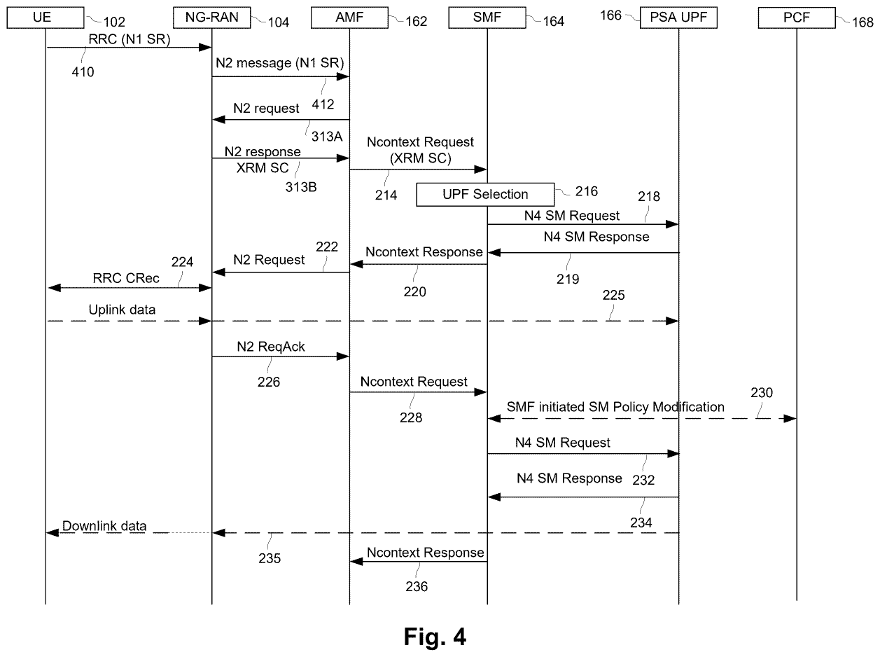

FIG. 4 is a signal diagram illustrating an AMF function retrieving XRM service capability information from an NG-RAN node as illustrated in FIG. 3 within an SR procedure context. The UE 102 may initiate an SR procedure by sending 410 a request (e.g., an N1 SR) to activate UP connection for one or more already-established PDU sessions (i.e., the already-established sessions are available in the UE). As already mentioned, the SR procedure may also be network triggered. The N1 SR may be conveyed via a radio resource control (RRC) message. The N1 SR includes a list of the one or more already-established PDU sessions (but unlike in 210 does not include XRM SI). The NG-RAN 104 then transmits 412 an N2 message to the AMF 162, the message encapsulating the N1 SR (but unlike the message sent at 212, this message does not include NG-RAN's XRM SC indication).

Then, as in FIG. 3, based on the UE context information, the AMF 162 sends 314A an NG-RAN XRM service capability request (e.g., an N2 message) to NG-RAN 104. In response, the AMF 162 receives 313B an NG-RAN XRM service capability response (which may also be an N2 message) from the NG-RAN 104. The AMF 162 then indicates 214 the NG-RAN's XRM service capability to the SMF(s) 164. Steps and actions 216-236 are substantially the same as in FIG. 2 so their description is omitted.

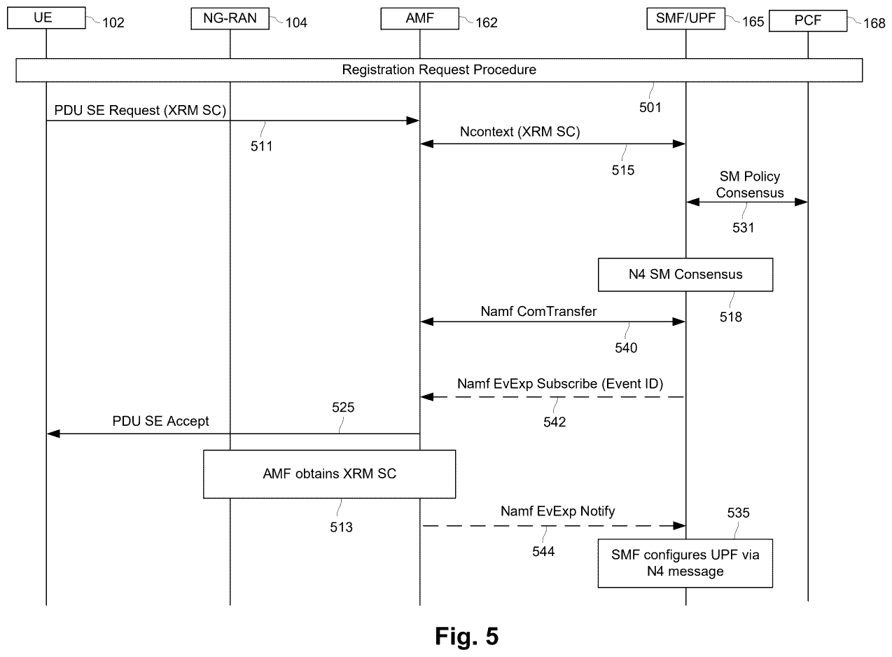

FIG. 5 is a signal diagram illustrating a CN element performing AMF acquiring XRM service capability information within an SR procedure context according to an embodiment. During a registration process procedure 501, as described in 3GPP technical specifications (e.g., 3 GPP TS 23. 502), the AMF 162 may configure NG-RAN with XRM service authorization via an initial context setup request message and then the NG-RAN stores the XRM service authorization in the UE context. The NG-RAN may then include the XRM service indication in an RRC message to the UE when the NG-RAN supports and enables handling PDU set based flows for XRM according to QoS.

The UE 102 sends 511 a PDU Session establishment request message including XRM SC indication to the AMF 162. The NG-RAN 104 thus indicates NG-RAN's XRM service capabilities (e.g., within an N2 message to the AMF) based on the XRM service authorization configured during the registration process procedure 501.

The AMF 162 then sends 515 an Ncontext message (e.g., an Nsmf_PDUSession_CreateSMContext Request) including NG-RAN's XRM service capabilities to the SMF/UPF 165. The SMF then performs 531 an SM policy association and modification (i.e., consensus) procedure with the PCF 168 to get PCC rules which may include PDU Set QoS parameters and PDU Set Information if applicable. The SMF/UPF 165 uses the PCC rules to perform QoS flow binding and configure UPF via N4 interface for PDU Set handling and marking. For example, the SMF sends an N4 Session Establishment/Modification Request to the UPF and the UPF acknowledges by sending an N4 Session Establishment/Modification Response (actions represented by box 518 in FIG. 5).

The SMF may then ask 540 the AMF 162 to provide NG-RAN's XRM service capability and then subscribe 542 to the AMF notification for the Event Exposure of NG-RAN's XRM service capability when the serving NG-RAN is changed for the UE. In one embodiment, the SMF may ask the AMF 162 to provide NG-RAN's XRM service capability using directly the subscribe message (e.g., an Namf_N2InfoSubscribe message). In response message, the NG-RAN 104 sends the XRM service capabilities to the SMF via the AMF (e.g., using an Namf_N2InfoNotify message).

The SMF may update 525 (1) QoS profiles of PDU Sessions stored by the NG-RAN using a N2 PDU Session Request message and (2) QoS rules stored in the UE using an N1 PDU Session Accept Establishment message. At some point in time, the AMF 162 may obtain 513 NG-RAN's XRM services capabilities from the NG-RAN. The AMF 162 sends 544, to the SMF, a notification including NG-RAN's XRM SC indication (e.g., an Namf_EventExposure_Notify message). Based on the PCC rules, the SMF performs QoS flow binding and configures 535 UPF (e.g., via N4 interface) for PDU Set based handling and marking.

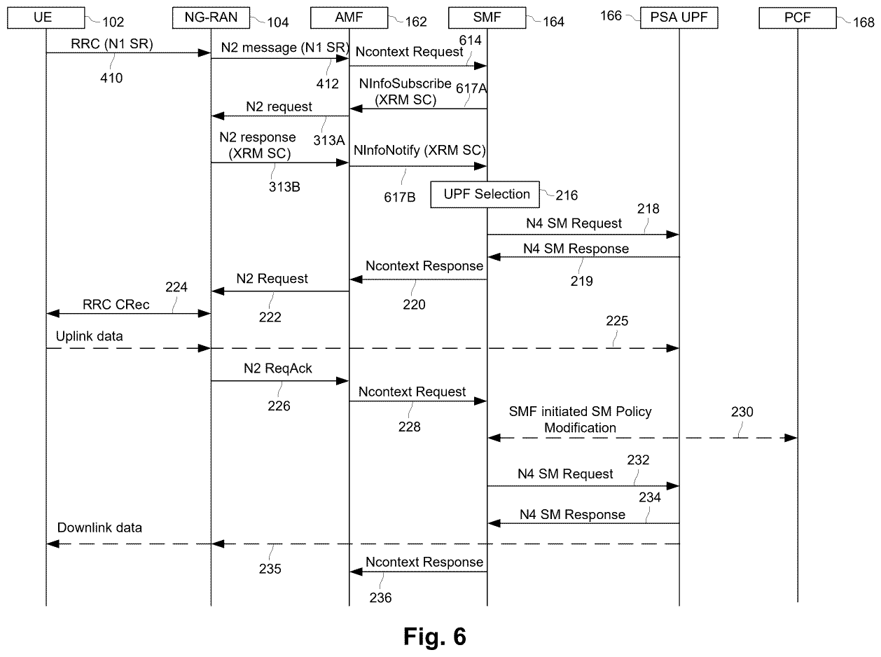

FIG. 6 is a signal diagram illustrating an SMF function initiating XRM service capability information retrieval within an SR procedure context according to another embodiment. The AMF 162 determines one or more already-established PDU sessions to be activated (i.e., the UP connections) and sends 614 an NContext message (e.g., an Nsmf_PDUSession_UpdateSMContext Request message) to SMF(s) associated with these PDU Session(s) with Operation Type set to “UP activate” to indicate establishment of UP resources for the PDU Session(s).

In view of the Operation Type being set to “UP activate”, the SMF 162 requests 617A the NG-RAN's XRM service capabilities from the NG-RAN via AMF. For example, the SMF 162 may use an Namf_Communication_N2InfoSubscribe message to subscribe for the delivery of information contained in a specific N2 message type for retrieving NG-RAN's XRM service capability for the UE, which allows SMF subscribe with the AMF to get notified a particular N2 message information.

The NG-RAN 104 replies 313B to SMF's request via the AMF 162, which sends 617B an NInfoNotify message indicating NG-RAN's XRM SC (e.g., using an Namf_Communication_N2InfoNotify message).

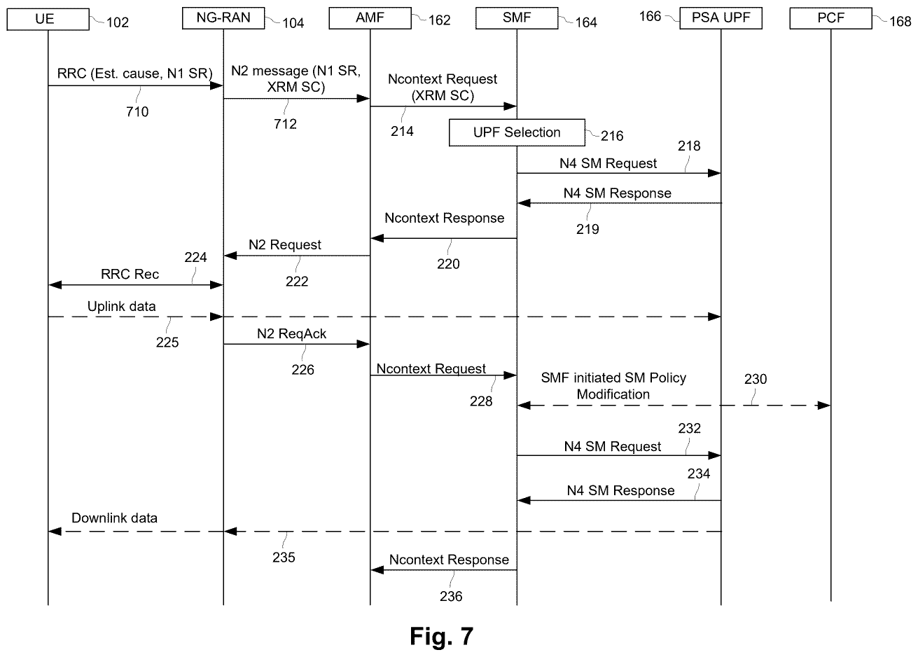

FIG. 7 is another signal diagram illustrating an NG-RAN's XRM service capability information exchanged within a SR procedure context according to an embodiment. FIG. 7 illustrates a scenario in which the NG-RAN's XRM service capabilities is provided to AMF and SMF during an SR procedure for activating PDU Session of XRM service as illustrated in FIG. 2. However, here the NG-RAN 104 indicates 712 its NG-RAN's XRM service capability in an N2 message to the AMF based on an establishment cause, which provides the reason the UE 102 requested 710 the establishment of an RRC connection, indicated in RRC message, (e.g., an RRC Setup Request message). For example, the existing establishment causes may provide higher priority (e.g., mo-Video Call, mt-Access, highPriorityAccess) when PDU sessions to be activated are for XRM services. Such establishment causes are not emergency, mps-PriorityAccess, mcs-PriorityAccess. One or more new establishment causes may indicate that the connection is for XRM services which requires PDU Set based QoS handling. A new establishment cause of high Priority-media may indicate that PDU Sessions to be activated is for XRM services. Other new establishment causes may indicate that the UP connection is for XRM services which requires PDU Set based QoS handling based on PDU Session to be activated or based on PDU Session Status. For the former case, the indication of the NG-RAN's XRM service capability is optional.

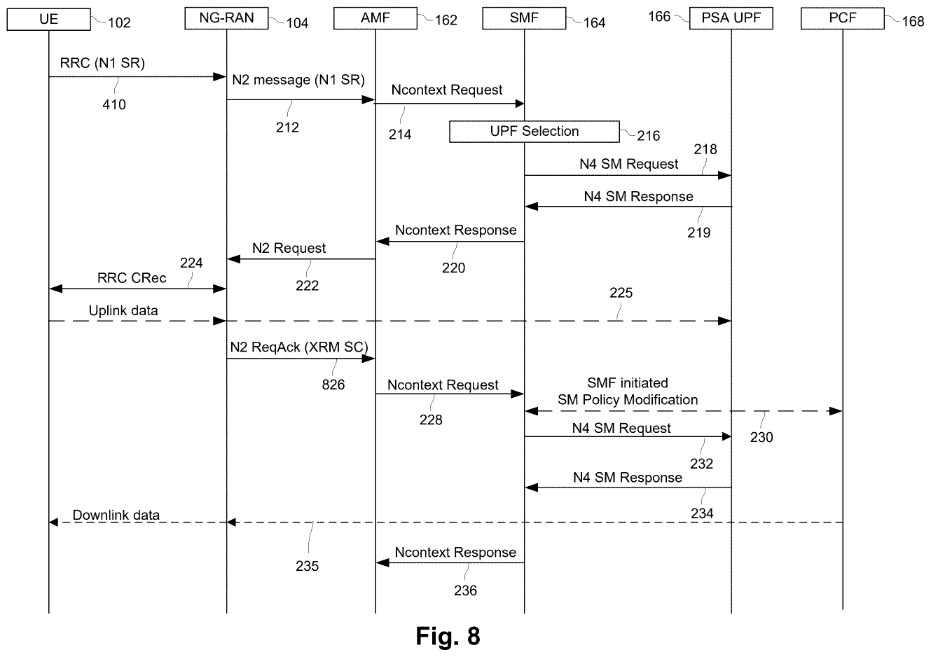

In one embodiment illustrated in FIG. 8, during an SR procedure, the NG-RAN provides XRM SC indication to the AMF based on the UE context received from the AMF and the list of PDU sessions to be established. That is, the NG-RAN includes NG-RAN's XRM SC indication in the N2 request acknowledgement message 826. The NG RAN may include the NG-RAN's XRM SC indication in view of the list of PDU sessions to be activated received from the UE in the SR request (e.g., 210). The NG-RAN 104 may include NG-RAN's XRM service capability in N2 SM information for the PDU Session that enables PDU Set based handling in NG-RAN. If the N2 SM information such indication(s), the SMF configures PSA UPF to perform PDU Set information marking for the QoS flow in scenarios such as: (i) 5GS registration, (ii) when access type is 3GPP access, (iii) when PDU session type is IP, (iv) when PDU session request type is ‘Initial request’ or ‘existing PDU Session’, (v) in case of non-roaming and local breakout, and (vi) when a UE state transition occurs (between CM-Idle and CM-Connected states, between RRC-Inactive and RRC-Connected states).

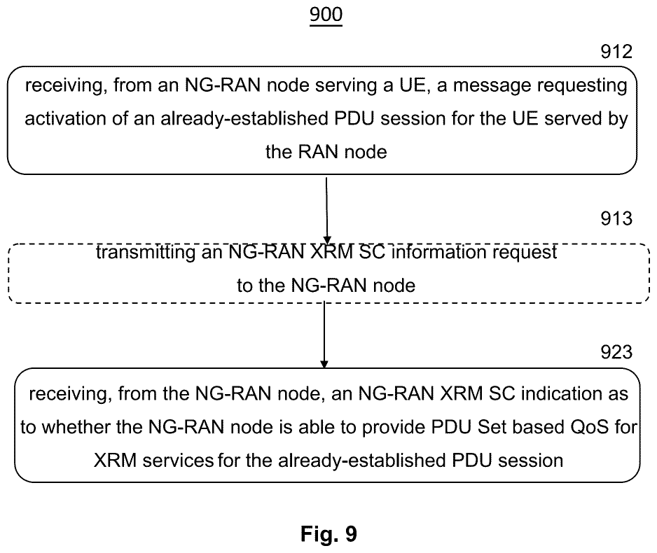

FIGS. 9-11 are flowcharts of methods performed by a CN element, an NG-RAN and a UE in a in an SR procedure context as illustrated in FIGS. 2-7.

FIG. 9 is a flowchart of a method 900 of a CN element in an SR procedure context according to an embodiment. The CN element hosts at least one CN function (such as, AMF or SMF) and has processing hardware as illustrated in FIG. 1. The method 900 includes receiving 912, from an NG-RAN node serving a UE, a message requesting activation of an already-established PDU session for the UE served by the RAN node. The receiving 912 corresponds to the message exchanges 212, 412, etc. in the signal diagrams. The method 900 may (i.e., optional as suggested by the dashed line) include transmitting 913 an NG-RAN XRM SC information request to the NG-RAN node. The transmitting 913 corresponds to the message exchanges 313A in the signal diagrams. The method 900 then includes receiving 923, from the NG-RAN node, an NG-RAN service capability indication as to whether the NG-RAN node is able to provide PDU Set based QoS for XRM services for the already established PDU session. The receiving 923 corresponds to the message exchanges 313B and 214 in the signal diagrams.

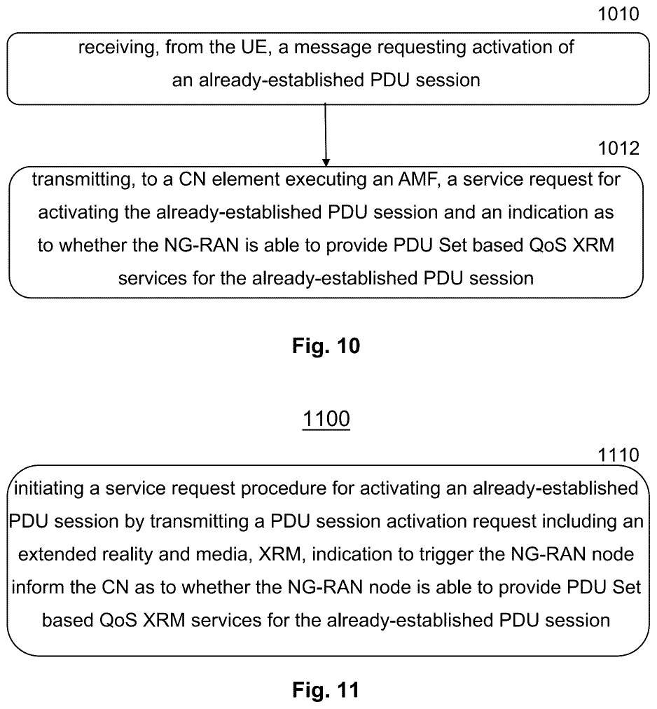

FIG. 10 is a flowchart of a method 1000 performed by an NG-RAN node (e.g., 104) in an SR procedure context according to an embodiment. Method 1000 includes receiving 1010, from the UE, a message requesting activation of an already-established PDU session. The receiving 1010 corresponds to the message exchanges 210, 410, etc. in the signal diagrams. The method 1000 further includes transmitting 1012, to a CN element executing an AMF, a service request for activating the already-established PDU session and an indication as to whether the NG-RAN is able to provide PDU Set based QoS for XRM services for the already-established PDU session. The transmitting 1012 corresponds to the message exchanges 212, 412, etc. in the signal diagrams.

FIG. 11 is a flowchart of a method 1100 performed by a UE (e.g., 102) in an SR procedure context according to an embodiment. The method 1000 includes initiating 1110 a service request procedure for activating an already-established PDU session by transmitting a PDU session activation request including an XRM service indication to trigger the NG-RAN node informing the CN as to whether the NG-RAN node is able to provide PDU Set based QoS for XRM services for the already-established PDU session. The initiating 1110 corresponds to the message exchanges 210, 410, etc. in the signal diagrams.

Various embodiments enhance the SR procedure currently described in the 3GPP technical specification as follows. In some embodiments, based on the UE context and a list of PDU sessions to be activated received from the AMF or the UE, the NG-RAN node determines whether to enable the PDU Set based handling for the QoS flows to be established. If the NG-RAN determines to enable the PDU Set based handling for at least one QoS flow, the NG-RAN node sends an N2 message (N2 session management (SM) information) to the SMF.

In some embodiments, the NG-RAN node includes the NG-RAN's XRM service capability (as a PDU set based handling support indication) in an N2 SM information of the N2 Request Ack message for the PDU Session. If the N2 SM information includes the NG-RAN's XRM service capability for one or more PDU Sessions to be established, the SMF configures PSA UPF to perform PDU Set information marking for the QoS flow of those PDU Sessions.

In some embodiments, if the N2 SM information includes the NG-RAN's XRM service capability, the SMF configures the PSA UPF to perform PDU Set information marking for the QoS flow. The SMF may determine whether to activate/deactivate PDU Set based Handling feature at the PSA UPF in the following situations (i.e., scenarios or procedures): (i) 5GS registration, (ii) access type is 3GPP access, (iii) PDU session type as IP, (iv) PDU session request type as ‘Initial request’ or ‘existing PDU Session’, (v) non-roaming and local breakout, (vi) UE state transition, (e.g. between CM-Idle and CM-Connected states, between RRC-Inactive and RRC-Connected states).

Reference throughout this section to “one embodiment” or “an embodiment” means that a particular feature, structure, or characteristic described in connection with an embodiment is included in at least one embodiment. Thus, the appearances of the phrases “in one embodiment” or “in an embodiment” in various places throughout the specification are not necessarily all referring to the same embodiment. Further, the particular features, structures or characteristics may be combined in any suitable manner in one or more embodiments.

Numerical adjectives “first”, “second”, and “third” do not imply any order (are not ordinals) but are markers to distinguish separate instances of similar elements. References to the singular (e.g., “a” or “an”, “the”) should include the plural unless clearly indicated otherwise.

As used herein, a phrase referring to “at least one of” or “one or more of” a list of items refers to any combination of those items, including single members. For example, “at least one of: a, b, or c” is intended to cover the possibilities of: a only, b only, c only, a combination of a and b, a combination of a and c, a combination of b and c, and a combination of a and b and c.

Although the features and elements of the present embodiments are described in the embodiments in particular combinations, each feature or element can be used alone without the other features and elements of the embodiments or in various combinations with or without other features and elements disclosed herein. The methods or flowcharts may be implemented in a computer program, software or firmware tangibly embodied in a computer-readable storage medium for execution by a specifically programmed computer or processor.

1-17. (canceled)

18. A wireless communication method performed by a core network (CN) element, the method comprising:
receiving a message comprising a service request (SR) requesting activation of a user plane connection for a list of already-established Packet Data Unit (PDU) sessions with a user equipment (UE) served by a radio access network (RAN) node; and
receiving an indication as to whether the RAN node is able to provide PDU Set based quality of service, QoS for extended reality and media (XRM) services for an already-established PDU session in the list.

19. The wireless communication method of claim 18, wherein the RAN node is an NG-RAN node, and the method further includes transmitting, to the NG-RAN node, an XRM service capability information request before the receiving of the indication.

20. The wireless communication method of claim 18, wherein the CN element executes a Session Management Function, SMF, the method further comprising:
obtaining the indication from an Access and Mobility Management Function, AMF; and
selectively activating the already-established PDU session according to the indication.

21. The wireless communication method of claim 20, wherein the selectively activating comprises:
instructing a User Plane Function, UPF, to enable PDU Set identification and marking on the PDU Set based QoS flows for the already-established PDU session according to the indication indicating that the RAN node is able to provide PDU Set based QoS for the XRM services.

22. The wireless communication method of claim 18, wherein the indication related to the RAN node is different from an XRM capability indication of a RAN node previously serving the UE.

23. The wireless communication method of claims 22, further comprising:
initiating a PDU session modification procedure for the already-established PDU sessions in the list.

24. The wireless communication method of claim 18, further comprising:
providing the PDU Set based QoS for a particular XRM service to the UE after activating the already-established PDU session.

25. A wireless communication device comprising:
a transceiver configured to exchange messages wirelessly with a user equipment (UE); and
a processor connected to the transceiver and configured
to receive a message comprising a service request (SR) requesting activation of a user plane connection for a list of already-established Packet Data Unit (PDU) sessions with the UE served by a radio access network (RAN) node;
to receive an indication as to whether the RAN node is able to provide PDU Set based quality of service, QoS for extended reality and media (XRM) services for an already-established PDU session in the list, and
to selectively activate the already-established PDU session according to the indication.

26. The wireless communication device of claim 25, wherein the processor is further configured to transmit an XRM service capability information request to the RAN node before the receiving of the indication.

27. The wireless communication device of claim 25, wherein the processor is further configured:
to execute a Session Management Function; and
to obtain the indication from an Access and Mobility Management Function,
wherein the Session Management Function and the Access and Mobility Management Function are defined in 3GPP technical specifications.

28. The wireless communication device of claim 25, wherein the processor is further configured
to initiate a PDU session modification procedure for the already-established PDU sessions in the list when the indication related to the RAN node is different from an XRM capability indication of a RAN node previously serving the UE.

29. The wireless communication device of claim 25, wherein the processor is further configured to provide the PDU Set based QoS for a particular XRM service to the UE after activating the already-established PDU session.

30. A wireless communication method performed by a radio access network (RAN) node serving a user equipment (UE), the method comprising:
receiving, from the UE, a message comprising a service request (SR) requesting activation of a user plane connection for already-established Packet Data Unit (PDU) sessions in a list; and
transmitting, to a core network (CN) element, the SR and an indication as to whether the RAN node is able to provide PDU Set based quality of service, QoS, to extended reality and media, XRM, services for an already-established PDU session in the list.

31. The wireless communication method of claim 30, wherein the transmitting includes sending the indication when the message requesting activation of the already-established sessions includes an XRM service indication.

32. The wireless communication method of claim 30, further comprising:
receiving, from the CN element in response to the transmitting of the service request, an XRM service capability information request which is associated with parameters of the PDU Set based QoS included in a QoS profile to provide the indication; and
the transmitting of the indication is triggered by the receiving of the XRM service capability information request.

33. The wireless communication method of claim 30, wherein the message requesting activation of the already-established PDU session is a radio resource control, RRC, message.

34. The wireless communication method of claim 30, wherein the receiving of the message comprising the SR and requesting activation of the UP connection for the already-established PDU sessions in the list and the transmitting of the SR and the indication pertain to a service request procedure.

35. The wireless communication method of claim 30, further comprising:
providing a particular XRM service to the UE with the PDU Set based QoS after the already-established PDU session is activated.

36. A wireless communication method performed by user equipment (UE) connected to a core network (CN) element via a radio access network, RAN, node, the method comprising:
initiating a service request procedure for activating a user plane connection for already-established Packet Data Unit (PDU) sessions in a list by transmitting a PDU session activation request and an extended reality and media (XRM) indication indicating that one of the already-established PDU sessions provides an XRM service.

37. A user equipment comprising:
a transceiver configured to exchange messages wirelessly with a core network element via a radio access network (RAN) node; and
a processor configured
to initiate a service request procedure for activating a user plane connection for already-established Packet Data Unit (PDU) sessions in a list by transmitting a PDU session activation request and an extended reality and media (XRM) indication indicating that one of the already-established PDU sessions provides an XRM service.
